(19) United States
(12) Patent Application Publication
(10) Pub. No.: US 2026/0087261 A1
(43) Pub. Date: Mar. 26, 2026

(54) SYSTEMS AND METHODS FOR MANAGING AND ORCHESTRATING CONVERSATIONS AT A VIRTUAL ASSISTANT SERVER

(71) Applicant: Kore.ai, Inc., Orlando, FL (US)

(72) Inventors: Rajkumar KONERU, Windermere, FL (US); Prasanna Kumar Arikala Gunalan, Hyderabad (IN); Sri Vishnu Sankar Srinivasan, Chennai (IN); Jayesh Arunkumar Jain, Bhusawal (IN)

(21) Appl. No.: 19/319,429

(22) Filed: Sep. 4, 2025

Related U.S. Application Data
(60) Provisional application No. 63/699,605, filed on Sep. 26, 2024.

(51) Int. Cl. G06F 40/35; G06F 9/451; G06F 40/40

(52) U.S. Cl. CPC G06F 40/35; G06F 9/453; G06F 40/40

(57) ABSTRACT

A method implemented by a virtual assistant server comprises: receiving a user input from a user device as part of an automated interaction with the user device. Based on the user input, one or more data chunks are identified from enterprise data. Further, one or more fulfillment types and fulfillment details corresponding to the one or more fulfillment types are determined based on the user input, a transcript of the automated interaction, a description of each of the fulfillment types, a description of each of a plurality of system intents, and the one or more data chunks. Further, one or more responses to the user input are determined by executing one or more fulfillment tasks based on the one or more fulfillment types and the fulfillment details. Subsequently, the virtual assistant server outputs the one or more responses to the user device.

This application claims priority of U.S. Provisional Patent Application Ser. No. 63/699,605, filed Sep. 26, 2024.

### FIELD

This technology generally relates to virtual assistants, and more particularly to methods, systems, and computer-readable media for managing and orchestrating conversations at a virtual assistant server using language models.

### BACKGROUND

Traditionally, intents from user inputs of virtual assistant-user conversations are determined using intent classification models that are trained with labeled training data sets. These training data sets are manually labeled by the enterprise users (e.g., developers, system administrators, business analysts, etc.). This is time consuming and dependent on the training data sets and the skill of enterprise users. As a result, such intent determination methods are prone to errors.

Further, the existing intent classification techniques are not good at understanding the context, especially when the user asks for or refers to the information that is already part of the conversation history (e.g., contextual follow-ups, inferred intents, etc.). Further, current intent classification techniques struggle to effectively manage multi-intent user requests, particularly when it comes to dynamically planning and executing the appropriate sequence of actions.

Furthermore, the dialog flow based virtual assistants struggle to effectively understand and handle conversational nuances such as, for example, a user asks to repeat a previous input (e.g., “say that again”, “what is it”, etc.), hold on (e.g., “give me a moment”, “hold for a sec” etc.), user asks clarifying questions (e.g., “where do I find it”, “I don't know”, “why do you need it”, etc.), user asks to restart, or the like. It is a time consuming and complex activity for the enterprise users to either hard code such conversational nuances into the virtual assistant configuration or provide labeled training data for such conversational nuances.

With the emergence of large language models (LLMs) and few-shot training, the need for elaborate training for the traditional intent classification models has been greatly reduced. However, when the classification has to be performed among a large number of intents, using few-shot training might result in inconsistent and inaccurate intent classification.

To address the above-mentioned limitations, there is a need for systems and methods to provide fluid and human-like conversation experience without the need for elaborate model training and creation of complex dialog flows.

### SUMMARY

In an example, the present disclosure relates to a method for managing and orchestrating conversations at a virtual assistant server using language models. The method implemented by a virtual assistant server comprises receiving a user input from a user device as part of an automated interaction with the user device. Based on the received user input, one or more data chunks are identified from enterprise data. The virtual assistant server determines one or more fulfillment types and fulfillment details corresponding to the one or more fulfillment types based on—the user input, a transcript of the automated interaction, a description of each of the fulfillment types, a description of each of a plurality of system intents, and the one or more data chunks. The virtual assistant server further determines one or more responses to the user input by executing one or more fulfillment tasks based on the determined one or more fulfillment types and the fulfillment details. Subsequently, the virtual assistant server outputs the determined one or more responses to the user device.

In another example, the present disclosure relates to a virtual assistant server comprising one or more processors and a memory. The memory coupled to the one or more processors which are configured to execute programmed instructions stored in the memory to receive a user input from a user device as part of an automated interaction with the user device. Based on the received user input, one or more data chunks are identified from enterprise data. Further, one or more fulfillment types and fulfillment details corresponding to the one or more fulfillment types are determined based on—the user input, a transcript of the automated interaction, a description of each of the fulfillment types, a description of each of a plurality of system intents, and the one or more data chunks. Further, one or more responses to the user input are determined by executing one or more fulfillment tasks based on the determined one or more fulfillment types and the fulfillment details. Subsequently, the determined one or more responses are output to the user device.

In another example, the present disclosure relates to a non-transitory computer readable storage medium storing instructions which when executed by one or more processors, causes the one or more processors to receive a user input from a user device as part of an automated interaction with the user device. Based on the received user input, one or more data chunks are identified from enterprise data. Further, one or more fulfillment types and fulfillment details corresponding to the one or more fulfillment types are determined based on—the user input, a transcript of the automated interaction, a description of each of the fulfillment types, a description of each of a plurality of system intents, and the one or more data chunks. Further, one or more responses to the user input are determined by executing one or more fulfillment tasks based on the determined one or more fulfillment types and the fulfillment details. Subsequently, the determined one or more responses are output to the user device.

### BRIEF DESCRIPTION OF THE DRAWINGS

FIG. 1 is a block diagram of an exemplary environment with a virtual assistant server configured to manage and orchestrate conversations using language models.

FIG. 1A is a block diagram of the virtual assistant platform of the virtual assistant server illustrated in FIG. 1.

FIGS. 2A and 2B are exemplary flow diagrams illustrating how interactions between one or more user devices and one or more virtual assistants are managed and orchestrated by the virtual assistant server illustrated in FIG. 1.

FIG. 3 is a flowchart of another exemplary method for managing and orchestrating conversations at the virtual assistant server illustrated in FIG. 1.

FIG. 4 is a table illustrating exemplary conversation data between a user at a user device and a virtual assistant managed by the virtual assistant server.

### DESCRIPTION

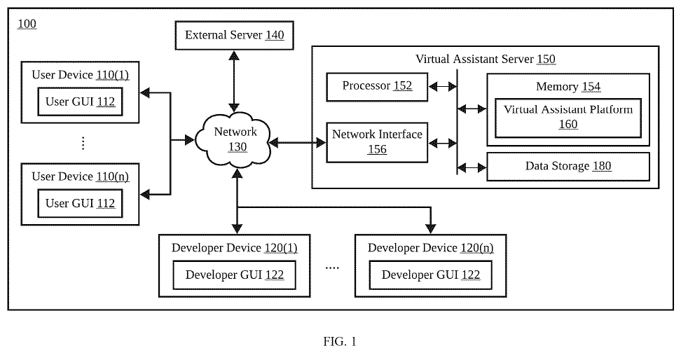

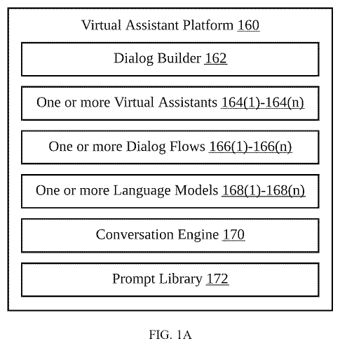

Examples of the present disclosure relate to an environment 100 (illustrated in FIG. 1) and, more particularly, to one or more components, systems, computer-readable media and methods for leveraging language models to manage and orchestrate conversations at a virtual assistant server. The environment 100 enables developers or administrators of enterprises operating enterprise devices to, by way of example, design, develop, deploy, manage, host, and analyze virtual assistants. Enterprises may deploy such virtual assistants to communicate with their customers (hereinafter referred to as “users”) through automated natural language interactions. An exemplary virtual assistant server 150 of the environment 100 is configured to orchestrate natural language conversations between the users and the virtual assistants.

FIG. 1 is a block diagram of an exemplary environment 100 for implementing the concepts and technologies disclosed herein. The environment 100 includes: one or more user devices 110(1)-110(n), one or more developer devices 120(1)-120(n), an external server 140, and a virtual assistant server 150 coupled together via a network 130, although the environment 100 may include other types and numbers of systems, devices, components, and/or elements in other topologies and deployments in other examples. Although not illustrated, the environment 100 may include additional network components, such as routers, switches, and other devices, which are well known to those of ordinary skill in the art and thus will not be described here.

The one or more user devices 110(1)-110(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more user devices 110(1)-110(n) may comprise one or more processors, one or more memories, one or more input devices such as a keyboard, a mouse, a display device, a touch interface, and/or one or more communication interfaces, which may be coupled together by a bus or other link, although the one or more user devices 110(1)-110(n) may have other types and/or numbers of other systems, devices, components, and/or elements in other examples. The one or more user devices 110(1)-110(n) may include software and hardware capable of communicating with the virtual assistant server 150 via the network 130. The users operating the one or more user devices 110(1)-110(n) provide user inputs (e.g. in text, voice, or a combination thereof) via one or more virtual assistants 164(1)-164(n) to the virtual assistant server 150. The virtual assistant server 150 processes these user inputs and generates responses via the virtual assistant platform 160, which executes the one or more virtual assistants 164(1)-164(n). In some examples, the virtual assistant server 150 interacts with the external server 140 to retrieve data or perform actions necessary to generate the responses. The one or more user devices 110(1)-110(n) may render and display the information received from the virtual assistant server 150.

The users at the one or more user devices 110(1)-110(n) may interact with the virtual assistant server 150 via one or more communication channels comprising enterprise messengers (e.g., Skype for Business, Microsoft Teams, Kore.ai Messenger, Slack, Google Hangouts, or the like), social messengers (e.g., Facebook Messenger, WhatsApp Business Messaging, Twitter, Lines, Telegram, or the like), web & mobile channels (e.g., a web application, a mobile application), interactive voice response (IVR) channels, voice channels (e.g., Google Assistant, Amazon Alexa, or the like), live chat channels (e.g., LivePerson, LiveChat, Zendesk Chat, Zoho Desk, or the like), a webhook channel, a short messaging service (SMS), email, a software-as-a-service (SaaS) application, voice over internet protocol (VOIP) calls, computer telephony calls, or the like. Although not illustrated in FIG. 1, it may be understood that to support voice-based communication channels, the environment 100 may also include, for example, a public switched telephone network (PSTN), a voice server, a text-to-speech (TTS) engine, and/or an automatic speech recognition (ASR) engine.

The one or more developers may access and interact with the functionalities exposed by the virtual assistant server 150 or the external server 140 via the network 130 using the one or more developer devices 120(1)-120(n). The one or more developer devices 120(1)-120(n) may include any type of computing device that can facilitate user interaction, for example, a desktop computer, a laptop computer, a tablet computer, a smartphone, a mobile phone, a wearable computing device, or any other type of device with communication and data exchange capabilities. The one or more developer devices 120(1)-120(n) may include software and hardware capable of communicating with the virtual assistant server 150 or the external server 140 via the network 130. Also, the one or more developer devices 120(1)-120(n) may comprise a graphical user interface (GUI) 122 to render and display the information received from the virtual assistant server 150 or the external server 140. The one or more developer devices 120(1)-120(n) may communicate with the virtual assistant server 150 or the external server 140 via one or more web applications or software hosted and/or managed by the virtual assistant server 150, one or more application programming interfaces (APIs) or one or more hyperlinks exposed by the virtual assistant server 150 and/or the external server 140 respectively, although other types and/or numbers of communication methods may be used in other examples.

The one or more developer devices 120(1)-120(n) may execute applications, such as web browsers or virtual assistant software, which may render the GUI 122, although other types and/or numbers of applications may render the GUI 122 in other example configurations. In one example, the one or more developers at the one or more developer devices 120(1)-120(n) may, by way of example, make selections, provide inputs using the GUI 122 or interact, by way of example, with data, icons, widgets, or other components displayed in the GUI 122.

The network 130 enables the one or more user devices 110(1)-110(n), the one or more developer devices 120(1)-120(n), the external server 140, or other such devices to communicate with the virtual assistant server 150. The network 130 may be, for example, an ad hoc network, an extranet, an intranet, a wide area network (WAN), a virtual private network (VPN), a local area network (LAN), a wireless LAN (WLAN), a wireless WAN (WWAN), a metropolitan area network (MAN), internet, a portion of the internet, a portion of the public switched telephone network (PSTN), a cellular telephone network, a wireless network, a Wi-Fi network, or a combination of two or more such networks, although the network 130 may include other types and/or numbers of networks in other topologies or configurations.

The network 130 may support protocols such as, Session Initiation Protocol (SIP), Hypertext Transfer Protocol (HTTP), Hypertext Transfer Protocol Secure (HTTPS), Media Resource Control Protocol (MRCP), Real Time Transport Protocol (RTP), Real-Time Streaming Protocol (RTSP), Real-Time Transport Control Protocol (RTCP), Session Description Protocol (SDP), Web Real-Time Communication (WebRTC), Transmission Control Protocol/Internet Protocol (TCP/IP), User Datagram Protocol (UDP), or Voice over Internet Protocol (VOIP), although other types and/or numbers of protocols may be supported in other topologies or configurations. The network 130 may also support standards or formats such as, for example, hypertext markup language (HTML), extensible markup language (XML), voiceXML, call control extensible markup language (CCXML), JavaScript object notation (JSON), although other types and/or numbers of data, media, and document standards and formats may be supported in other topologies or configurations. The network interface 156 of the virtual assistant server 150 may include any interface that is suitable to connect with any of the above-mentioned network types and communicate using any of the above-mentioned network protocols, standards, or formats.

The external server 140 may host and/or manage one or more language models such as, for example, LLMs. In one example, the one or more LLMs may be pre-trained general purpose LLMs (e.g., LLAMA 2, Claude, Cohere, Mistral 7B, Flan T5, BERT, GPT 3.5, GPT 4, . . . ) or fine-tuned LLMs for an enterprise or one or more domains. The external server 140 may create, host, and/or manage the one or more LLMs based on the training provided by the one or more developers at the one or more developer devices 120(1)-120(n). The external server 140 may be a cloud-based server or an on-premises server. The one or more LLMs may be accessed using application programming interfaces (APIs). In another example, the one or more LLMs may be hosted by the external server 140 and managed remotely by the virtual assistant server 150. In another example, the one or more LLMs may be hosted and/or managed by the virtual assistant server 150.

An LLM is a type of artificial intelligence and machine learning (AI/ML) based model that is used to process natural language data for tasks, such as natural language processing, text mining, text classification, machine translation, question-answering, text generation, or the like. The LLM uses deep learning or neural networks to learn language features or data patterns from large amounts of training data, which is then used to generate predictions or features or patterns from unseen data. The LLM can be used to generate language features such as word embeddings, part-of-speech tags, named entity recognition, sentiment analysis, or the like. Unlike traditional rule-based NLP systems, the LLM does not rely on pre-defined rules or templates to generate text or responses. Instead, the LLM uses a probabilistic approach to generate text, where the LLM calculates the probability of each word in the text based on the patterns the LLM learned from the training data.

The virtual assistant server 150 includes a processor 152, a memory 154, a network interface 156, and a data storage 180, although the virtual assistant server 150 may include other types and/or numbers of components in other examples. In addition, the virtual assistant server 150 may include an operating system (not shown). In one example, the virtual assistant server 150, one or more components of the virtual assistant server 150, and/or one or more processes performed by the virtual assistant server 150 may be implemented using a networking environment (e.g., cloud computing environment). In one example, the capabilities of the virtual assistant server 150 may be offered as a service using the cloud computing environment. Although illustrated as a single server, it may be understood that the virtual assistant server 150 may comprise one or more servers that may be distributed across different computing environments, including, by way of example, on-premises systems, cloud-based platforms, or hybrid architectures.

The components of the virtual assistant server 150 may be coupled by a graphics bus, a memory bus, an Industry Standard Architecture (ISA) bus, an Extended Industry Standard Architecture (EISA) bus, a Micro Channel Architecture (MCA) bus, a Video Electronics Standards Association (VESA) Local bus, a Peripheral Component Interconnect (PCI) bus, a PCI-Express (PCIe) bus, a serial advanced technology attachment (SATA) bus, a Personal Computer Memory Card Industry Association (PCMCIA) bus, a Small Computer Systems Interface (SCSI) bus, or a combination of two or more of these, although other types and/or numbers of buses may be used in other examples.

The processor 152 of the virtual assistant server 150 may execute one or more computer-executable instructions stored in the memory 154 for performing the methods illustrated and described with reference to the examples herein, although the processor 152 may execute other types and numbers of instructions and perform other types and numbers of operations in other examples. The processor 152 may comprise one or more central processing units (CPUs), or general-purpose processors with one or more processing cores although other types of processor(s) may be used in other examples. Although the virtual assistant server 150 may comprise multiple processors, only a single processor (i.e., the processor 152) is illustrated in FIG. 1 for simplicity.

The memory 154 and the data storage 180 of the virtual assistant server 150 is an example of a non-transitory computer-readable storage medium configured to store data, program code, or instructions that, when executed by the processor 152, perform one or more of the examples described below. The memory 154 may be a random access memory (RAM), a dynamic random access memory (DRAM), a static random access memory (SRAM), a persistent memory (PMEM), a non-volatile dual in-line memory module (NVDIMM), a hard disk drive (HDD), a read only memory (ROM), an erasable programmable read-only memory (EPROM), an electrically erasable programmable read-only memory (EEPROM), a programmable ROM (PROM), a flash memory, a compact disc (CD), a digital video disc (DVD), a magnetic disk, a universal serial bus (USB) memory card, a memory stick, distributed storage systems, cloud-based object stores, or a combination of two or more of these. It may be understood that the memory 154 may include other electronic, magnetic, optical, electromagnetic, infrared or semiconductor based non-transitory computer readable storage medium which may be used to tangibly store instructions, which when executed by the processor 152, perform the disclosed examples. The non-transitory computer readable medium is not a transitory signal per se and is any tangible medium that contains and stores the instructions for use by or in connection with an instruction execution system, apparatus, or device. Examples of the programmed instructions and steps stored in the memory 154 are illustrated and described by way of the description and examples herein.

As illustrated in FIG. 1, the memory 154 may include instructions corresponding to a virtual assistant platform 160 of the virtual assistant server 150, although other types and/or numbers of instructions in the form of programs, functions, methods, procedures, definitions, subroutines, or modules may be stored in other examples. The memory 154 may also include data structures storing information corresponding to the virtual assistant platform 160. The virtual assistant server 150 receives communications or instructions from one or more users at the one or more user devices 110(1)-110(n) or one or more developers at the one or more developer devices 120(1)-120(n) and provides responses to the received communications or perform necessary actions based on the received instructions.

The network interface 156 may include hardware components, software modules, or a combination thereof for implementing one or more communication protocols, such as wired, wireless, or optical networking protocols. Although not shown in FIG. 1, the network interface 156 may comprise, by way of example, one or more of: a network adapter, modem, transceiver, router, gateway, or virtualized communication interface. The network interface 156 may further support secure communication using encryption or authentication mechanisms to preserve data integrity and confidentiality.

The network interface 156 is configured to facilitate communication between the virtual assistant server 150 and other components of the environment 100 over the network 130, although the network interface 156 may enable communications with other types and/or number of components in other examples. The network interface 156 facilitates bidirectional data exchange with the one or more user devices 110(1)-110(n), the one or more developer devices 120(1)-120(n), or the external server 140 to support transmission of, by way of example, user inputs, virtual assistant responses, configuration data, training data, or system updates.

The data storage 180 of FIG. 1 may store enterprise data such as, for example, products, solutions, services, business rules, product and service information, privacy policy, terms of service, acceptable use policy, cookie policy, domain information, user intents information (e.g., intent names, intent descriptions, few-shot examples), one or more intent hierarchies (e.g., may be stored as JSON objects), although the data storage 180 may store other types of information in other examples. The data storage 180 may store the enterprise data in the form of, for example, frequently asked questions (FAQs), online content (e.g., articles, e-books, magazines, PDFs, blogs, whitepapers, case studies, . . . ), audio-video data (e.g., webinars, demos, . . . ), graphical data (e.g., infographics), or the like, that may be organized as relational data, tabular data, knowledge graph, or the like. In one example, the virtual assistant server 150 ingests enterprise data and breaks down the enterprise data such as documents into smaller, semantically meaningful text segments called data chunks. These data chunks are then converted into multi-dimensional vector embeddings, by way of example, using a language model. The vector embeddings are then indexed in the data storage 180.

The enterprise data stored in the data storage 180 may be accessed by the virtual assistant platform 160 while handling user conversations. For example, the virtual assistant server 150 identifies the most relevant data chunks from the vector space, by way of example, based on their similarity to the user input. Also, while developing or training the virtual assistants, the developers at the one or more developer devices 120(1)-120(n) may access the enterprise data stored in the data storage 180, for example, using the GUI 122, although other manners for accessing the enterprise data may be used. The enterprise data stored in the data storage 180 may be updated periodically or dynamically by the enterprise.

The data storage 180 may comprise one or more databases, some of which may be internal or external to the virtual assistant server 150. The data storage 180 of the virtual assistant server 150 may be implemented using one or more types of databases, including but not limited to: relational databases, NoSQL databases, vector databases, key-value stores, document databases, graph databases, time-series databases, and distributed or cloud-based databases, or a combination of two or more of these, although there may be other types and/or numbers of databases in other examples. In some examples, the data storage 180 may comprise a hybrid architecture that integrates multiple database types. The data storage 180 may comprise various types of non-transitory computer-readable storage media, including, for example, magnetic disks, solid-state drives, flash memory, optical storage, or distributed cloud storage systems. Portions of the one or more databases may further be cached in volatile memory such as random-access memory (RAM) to enable faster query execution and interaction with the virtual assistant server 150. In certain implementations, the data storage 180 may employ a layered architecture, wherein persistent storage maintains enterprise data, conversation history, and vector embeddings, while in-memory storage is used for temporary state management and real-time conversational processing. Although there may be multiple databases, a single data storage 180 is illustrated in FIG. 1 for simplicity.

FIG. 1A is a block diagram of the virtual assistant platform 160 of the virtual assistant server 150 illustrated in FIG. 1. As illustrated in FIG. 1A, the virtual assistant platform 160 comprises instructions or data corresponding to a dialog builder 162, one or more virtual assistants 164(1)-164(n), one or more dialog flows 166(1)-166(n), one or more language models 168(1)-168(n), a conversation engine 170, and a prompt library 172, although the virtual assistant platform 160 may include other types and/or numbers of modules or components in other examples.

The dialog builder 162 of the virtual assistant platform 160 may be served from or hosted on the virtual assistant server 150 and may be accessible as a website, a web application, or a software-as-a-service (SaaS) application, although the dialog builder 162 may be accessible in other types and/or numbers of ways in other examples. The one or more developers at the one or more developer devices 120(1)-120(n) may design, create, configure, or train the one or more virtual assistants 164(1)-164(n) via the dialog builder 162. In one example, the functionalities of the dialog builder 162 may be exposed as the GUI 122 rendered in a web page in a web browser accessible using the one or more developer devices 120(1)-120(n), such as a desktop or a laptop, although the functionalities of the dialog builder 162 may be accessed using other types and/or numbers of methods in other examples. For example, the settings, configuration, or functionalities of the dialog builder 162 may be exposed as the GUI 122 rendered in a web page in the web browser accessible by the developers at the one or more developer devices 130(1)-130(n). The one or more developers at the one or more developer devices 120(1)-120(n) may interact with user interface (UI) components, such as windows, tabs, widgets, or icons in the GUI 122 rendered in the one or more developer devices 120(1)-120(n) to create, train, deploy, manage or optimize the one or more virtual assistants 164(1)-164(n). The dialog builder 162 described herein can be integrated with different application platforms, such as development platforms or development tools or components thereof already existing in the marketplace.

After the one or more virtual assistants 164(1)-164(n) are deployed, the users at the one or more user devices 110(1)-110(n) may communicate with the one or more virtual assistants 164(1)-164(n) to, for example, purchase products, raise complaints, access services provided by the enterprise, to know information about the products or services offered by the enterprise, or the like. Each of the one or more virtual assistants 164(1)-164(n) may be configured to handle user inputs corresponding to one or more user intents in one or more domains and each of the one or more user intents may be further defined using a dialog flow. A user intent refers to a purpose of the user at one of the user devices 110(1)-110(n) that one or more of the virtual assistants 164(1)-164(n) needs to fulfill. Additionally, each user intent is associated with one or more entities, which are specific pieces of information identified in the user input that provide additional context or details needed to fulfill the user intent. For example, in a user input—“Book me a flight to Orlando for next Sunday,” the user intent is “Book Flight”, and the entities are “Orlando” and “Sunday.” In one example, each of the one or more virtual assistants 164(1)-164(n) may be configured using other methods, such as software code in other configurations.

Further, as illustrated in FIG. 1A, the one or more virtual assistants 164(1)-164(n) are associated with one or more dialog flows 166(1)-166(n). In one example, the one or more developers at the one or more developer devices 120(1)-120(n) may interact with the UI components, such as windows, tabs, widgets, or icons of the GUI 122 of dialog builder 162 rendered in the one or more developer devices 120(1)-120(n) to create the one or more dialog flows 166(1)-166(n) for the one or more user intents. A dialog flow of a user intent may refer to a sequence of interactions in a conversation between a user and a virtual assistant. In one example, a dialog flow 166(1) of the user intent associated to a virtual assistant 164(1) comprises a plurality of interconnected nodes comprising, for example, an intent node, one or more entity nodes, one or more context nodes, one or more service nodes, one or more confirmation nodes, one or more message nodes, or the like, that define steps to be executed to fulfill the user intent. Each of the plurality of interconnected nodes of the dialog flow 166(1) may be configured to handle one of a plurality of interaction types, such as, for example, prompting and gathering information from the user, providing information/response to the user, prompting the one or more language models 168(1)-168(n), making one or more service calls, or performing any other specific action. Each node of the dialog flow 166(1) represents a specific point in the conversation and edges between the nodes represent possible paths that the conversation can take.

In some examples, the one or more virtual assistants 164(1)-164(n) may be implemented as artificial intelligence (AI) agents, each capable of reasoning over inputs, invoking external tools or services, and adapting responses dynamically based on context. In such examples, the associated dialog flows 166(1)-166(n) may be expressed as agentic flows, wherein the sequence of interactions extends beyond static paths of predefined nodes and includes autonomous decision-making, task orchestration, and multi-step reasoning. These agentic flows allow the one or more virtual assistants 164(1)-164(n) to select appropriate system actions, invoke fulfillment tasks, and manage conversation progressions in a manner that blends deterministic dialog design with adaptive agent behavior.

Referring back to FIG. 1A, the virtual assistant platform 160 may host and/or manage the one or more language models 168(1)-168(n), such as, for example, artificial intelligence and machine learning (AI/ML) based models, transformer based models, generative pre-trained transformers (GPT) models, hybrid models, or the like which can process, understand and generate natural language text. The one or more language models 168(1)-168(n) may be created, trained, hosted, deployed, or managed by the virtual assistant platform 160 based on inputs provided by the one or more developers using the one or more developer devices 120(1)-120(n). In one example, the one or more language models 168(1)-168(n) may comprise a pre-trained general purpose LLM (e.g., LLAMA 3.3, Claude 3, Cohere, Mistral 7B, Flan T5, GPT 3.5, GPT 4, or the like) or a fine-tuned LLM for an enterprise or one or more domains. The one or more language models 168(1)-168(n) may also comprise: machine learning models, deep learning models, natural language processing (NLP) models, small language models (SLMs), foundation models, transformer-based models, recurrent neural network (RNN) models, convolutional neural network (CNN) models, sequence-to-sequence models, retrieval-augmented generation (RAG) models, hybrid symbolic-neural models, rule-based models, ensemble models, or generative models, although there may be other types and/or numbers of language models in other examples.

In one example, the one or more language models 168(1)-168(n) may be hosted and/or managed by the external server 140. In another example, the one or more language models 168(1)-168(n) may be hosted on the external server 140 and managed remotely by the virtual assistant server 150. In these examples, the virtual assistant server 150 may communicate with the one or more language models 168(1)-168(n), by way of example, using corresponding APIs to respond to user inputs. Although illustrated as a single server, it may be understood that the external server 140 may comprise one or more servers that may be distributed across different computing environments, including, by way of example, on-premises systems, cloud-based platforms, or hybrid architectures.

As part of managing conversations between the users at the one or more user devices 110(1)-110(n) and the one or more virtual assistants 164(1)-164(n), the virtual assistant server 150 may prompt the one or more language models 168(1)-168(n) to perform tasks, such as, for example, intent classification, entity extraction, intent resolution or disambiguation, sentiment detection, response generation, response rephrasing, generating prompts for the users, text summarization, language translation, question-answering, although other types and/or numbers of tasks may be performed in other examples. In one example, the virtual assistant server 150 prompts the one or more language models 168(1)-168(n) based on the prompt templates predefined in the prompt library 172. The prompt library 172 refers to a collection of prompt templates that are predefined by the one or more enterprise users and can be used to instruct a language model to respond in a specific way. In one example, the predefined prompt templates may comprise one or more textual prompts that are used for providing one or more inputs such as, for example, conversation history, current user input, one or more business rules, one or more conversation rules, one or more instructions, or few-shot examples, although the textual prompts may comprise other types and/or numbers of inputs in other examples. A prompt may be defined as one or more text-based instructions provided to one of the language models 168(1)-168(n) comprising one or more sentences, one or more phrases, or a single word that provides context for the language model to generate a required output. The few-shot examples are a set of example conversations or conversation volleys that guide the one or more language models 168(1)-168(n) to understand the overall flow of the conversation for specific user intent(s). The one or more language models 168(1)-168(n) may learn patterns and gain a better understanding of the desired conversational behavior from the few-shot examples.

The conversation engine 170 orchestrates the conversations between the one or more users at the one or more user devices 110(1)-110(n) and the virtual assistant server 150 by executing the one or more virtual assistants 164(1)-164(n). The conversation engine 170 is responsible for orchestrating user conversations by communicating with various components of the virtual assistant server 150 to perform various actions (e.g., understanding the user input, identifying user intent(s) of the user input, disambiguating user intents, extracting entities from the user input, retrieving relevant data, generating a response to the user input, transmitting the response to the user, or the like) and routing data between different components of the virtual assistant server 150. For example, the conversation engine 170 may communicate with the one or more language models 168(1)-168(n) or other components of the virtual assistant server 150 to orchestrate conversations with the users at the one or more user devices 110(1)-110(n).

Further, the conversation engine 170 may perform various tasks such as, for example, session initialization, session management (state management), or the like, corresponding to each user conversation with the virtual assistant server 150. In one example, the conversation engine 170 may be implemented as a finite state machine that uses states and state information to orchestrate conversations between the one or more user devices 110(1)-110(n) and the virtual assistant server 150. As part of the session management of each of the conversations between the one or more user devices 110(1)-110(n) and the one or more virtual assistants 164(1)-164(n), the conversation engine 170 stores, tracks, and updates session data such as, for example, conversation context object. The conversation context object refers to a data structure (e.g., JSON-JavaScript Object Notation) that holds relevant information about the ongoing interaction or session between the user device 110(1) and the virtual assistant 164(1). This information is used by the conversation engine 170 and the one or more language models 168(1)-168(n) to understand and manage the flow of conversation more effectively. The conversation context object may comprise one or more of, for example, conversation transcript, the identified user intent(s) of the one or more user inputs, one or more identified entities from the one or more user inputs, or identified language, although the conversation context object may comprise any other types of and/or numbers of information required to fulfill the user intent(s).

Further, the conversation engine 170 may manage digressions or interruptions provided by the users at the one or more user devices 110(1)-110(n) during the conversations with the one or more virtual assistants 164(1)-164(n). Additionally, the conversation engine 170 may generate and manage conversation transcripts of each of the conversations managed by the virtual assistant server 150. In one example, the virtual assistant server 150 may store the conversation transcripts generated by the conversation engine 170 in the memory 154 or any other database hosted or managed by the virtual assistant server 150. In another example, the conversation transcripts generated by the conversation engine 170 may be stored on one or more databases or on cloud storage(s) that are external to the virtual assistant server 150.

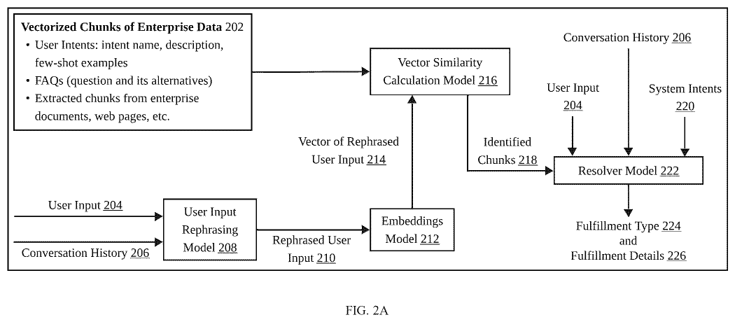

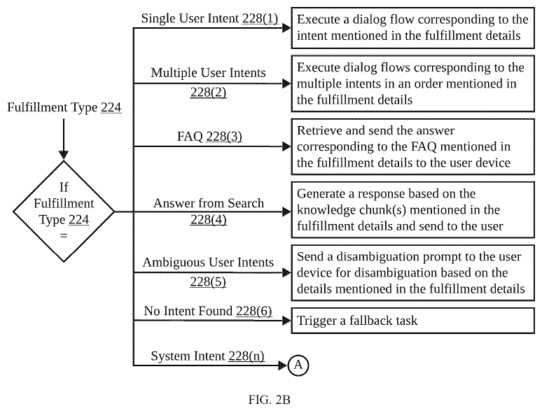

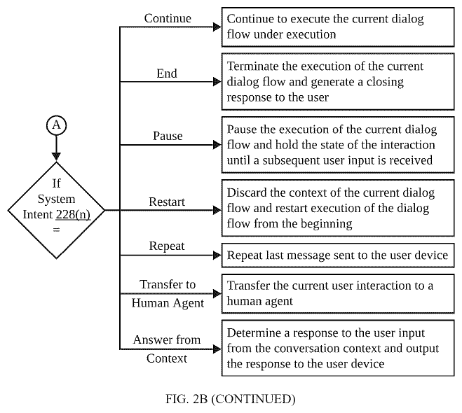

FIGS. 2A and 2B are exemplary flow diagrams illustrating how interactions between the one or more user devices 110(1)-110(n) and the one or more virtual assistants 164(1)-164(n) are managed and orchestrated by the virtual assistant server 150. Although not illustrated in FIG. 2A, other components of the environment 100 may also be used to implement the exemplary method disclosed herein. A user input rephrasing model 208 is a language model configured to receive a user input 204 and generate a rephrased user input 210 that standardizes linguistic variations. An embeddings model 212 is a language model configured to generate a vector representation 214 of the rephrased user input 210. A vector similarity calculation model 216 is a language model configured to compute similarity scores between the vector of the rephrased user input 214 and a plurality of vectorized chunks of enterprise data 202. A re-ranker model (not illustrated) is a language model configured to reorder identified enterprise data chunks 202 based on the similarity scores. A resolver model 222 is a language model configured to determine one or more fulfillment types 224 and corresponding fulfillment details 226 in response to the user input 204. Although the user input rephrasing model 208, the embeddings model 212, the vector similarity calculation model 216, the re-ranker model, and the resolver model 222 are described herein with particular configurations, in other examples the models may be implemented in alternative manners. In such examples, different types or numbers of inputs may be received, and different types or numbers of outputs may be generated.

In one example, one of the one or more language models 168(1)-168(n) may be configured to perform multiple functions within the virtual assistant server 150, such as acting as the user input rephrasing model 208, the embeddings model 212, the vector similarity calculation model 216, the re-ranker model, and the resolver model 222. In another example, different ones of the language models 168(1)-168(n) may individually perform each of the models and functions illustrated in FIG. 2A. In yet another example, a combination of shared and dedicated language models may be employed, such that one language model executes two or more of these functions while other language models perform distinct functions.

As illustrated in FIG. 2A, enterprise data of an enterprise may initially be chunked and each chunk may be vectorized (hereinafter referred to as “vectorized chunks of enterprise data 202”) by the virtual assistant server 150, using one or more vectorization techniques such as, but not limited to, Word2Vec, Word Embeddings, Bag of Words (BoW), although any other known vectorization techniques may be used. Further, in this example, the chunks from the enterprise documents may be extracted using one or more chunking strategies such as, for example, section-based chunking, paragraph-based chunking, sentence-based chunking, fixed-size sliding window-based chunking, overlapping sliding windows-based chunking, semantic chunking, hybrid hierarchical chunking, recursive chunking, layout-aware chunking, although other types and/or numbers of chunking strategies may be used in other examples. Further, in this example, the chunks from the webpages may be extracted using one or more chunking strategies such as, for example, Document Object Model (DOM)-based chunking, content-density chunking, heading hierarchy chunking, sentence-based chunking, fixed-size sliding window-based chunking, overlapping sliding windows-based chunking, semantic chunking, although other types and/or numbers of chunking strategies may be used in other examples.

The virtual assistant server 150 may index and store the enterprise data chunks and the vectorized chunks of enterprise data 202 in the data storage 180. In one example, the enterprise data chunks and the vectorized chunks of enterprise data 202 may be indexed and stored on one or more other databases either internal or external to the virtual assistant server 150. The enterprise data may comprise: details of each of a plurality of user intents (e.g., intent name, intent description, few-shot examples, etc.); frequently asked questions (FAQs) and corresponding alternate questions; extracted chunks from: enterprise documents (e.g., PDFs, word files, text files, research papers, etc.), webpages, etc. related to products, services, or policies; or the like. Although the enterprise data may comprise other types or formats of data in other examples. In this example, the details of each user intent comprising: intent name, intent description, or few-shot examples corresponding to the user intent is considered as a single chunk. Similarly, in this example, each FAQ along with the corresponding alternate questions is considered as a single chunk.

Further, for example when the virtual assistant server 150 receives a user input 204 as part of an ongoing conversation between a user at the user device 110(1) and a virtual assistant 164(1), the virtual assistant server 150 prompts a user input rephrasing model 208 to generate a rephrased user input 210. The prompt to the user input rephrasing model 208 comprises: one or more instructions to the user input rephrasing model 208, response format, and the user input 204. If a conversation history 206 (i.e., a transcript of the conversation) exists for the ongoing conversation, the virtual assistant server 150 may also provide the conversation history 206 as part of the prompt to the user input rephrasing model 208, so that the user input rephrasing model 208 may accurately generate the rephrased user input 210 based on the conversation context. As part of the prompt, the virtual assistant server 150 may also provide one or more examples illustrating how to rephrase the user input 204.

Further, the virtual assistant server 150 prompts an embeddings model 212 to generate a vector of the rephrased user input 214. The prompt to the embeddings model 212 comprises one or more instructions to the embeddings model 212 and the rephrased user input 210. In one example, the user input 204 may be directly provided as an input to the embeddings model 212 for generating a vector of the user input 204 instead of the rephrased user input 210. Further, as illustrated in FIG. 2A, the virtual assistant server 150 prompts a vector similarity calculation model 216 to calculate similarity scores between the vector of the rephrased user input 214 and each of the vectorized chunks of enterprise data 202. The vector similarity calculation model 216 may calculate vector similarity based on at least one of the techniques such as, but not limited to, cosine similarity, dot product similarity, or Euclidean distance, although other types and/or numbers of techniques may be used in other examples. The prompt to the vector similarity calculation model 216 comprises: one or more instructions, output format, the vector of the rephrased user input 214, and the vectorized chunks of enterprise data 202. Further, the virtual assistant server 150 may identify one or more of the vectorized chunks of enterprise data 202 that have a similarity with the vector of the rephrased user input 214 greater than or equal to a threshold similarity score predefined by an enterprise user, and provide a prompt to a re-ranker model (not illustrated in FIG. 2A) to rank the identified one or more of the vectorized chunks of enterprise data 202 based on the similarity scores. The prompt to the re-ranker model may comprise: the identified one or more of the vectorized chunks of enterprise data 202 along with the corresponding calculated similarity scores, the required output format, and one or more instructions to the re-ranker model, although the prompt to the re-ranker model may comprise other types and/or numbers of information in other examples.

Further, as illustrated in FIG. 2A, the virtual assistant server 150 prompts a resolver model 222 to determine one or more fulfillment types 224 and fulfillment details 226 corresponding to the one or more fulfillment types 224 to respond to the user input 204. In this example, the resolver model 222 acts as a conversation orchestrator, which identifies the next steps to be performed to take the conversation forward. The prompt to the resolver model 222 may comprise one or more of: one or more instructions, output format, the identified one or more of the vectorized chunks of enterprise data 202 (hereinafter “identified chunks 218”), the user input 204, the conversation history 206—the transcript of the conversation (if existing), description of each of a plurality of system intents 220, and a user context (not illustrated). In one example, instead of providing both the user input 204 and the conversation history 206, only the rephrased user input 210 may be provided as part of the prompt to the resolver model 222, which significantly reduces: the number of input tokens in the prompt; and the time to process the prompt and generate an output, by the resolver model 222. The user context refers to information corresponding to the user that the resolver model 222 may use to tailor the responses and interactions. The user context may comprise information such as, for example, user preferences, past interactions, user profile information, personal details, demographics, although the user context may comprise other types and/or numbers of user related data in other examples.

The one or more enterprise users may define each user intent by providing-intent name, intent description, and example user inputs corresponding to the user intent. Table-1 below comprises a few example user intents and corresponding descriptions and example user inputs in banking domain, which may be stored as part of the enterprise data. In one example, each user intent along with the corresponding description and the example user inputs is considered as a single chunk. For example, in the Table-1 below, the user intent: “Check Balance” and the corresponding description and the example user inputs are together considered as a single chunk.

TABLE 1

| User Intent | Description | Example User Inputs |
|---|---|---|
| Check Balance | User wants to know the current | I want to check the balance in my |
| | balance of his/her bank | savings account. |
| | account(s). | What's my current balance? |
| Transfer Funds | User wants to transfer money | Transfer $200 to my checking |
| | between own bank accounts or to | account. |
| | another person. | Send $500 to John. |
| View Transaction | User asks to see past bank | Show me my last 5 transactions. |
| History | transactions or recent account | What was my last payment? |
| | activity. | |
| Report Lost/Stolen | User wants to report a lost or | I lost my credit card, please block it. |
| Card | stolen debit/credit card. | Someone stole my debit card, what |
| | | should I do? |
| Request New Card | User wants to apply for a new | I need a new debit card. |
| | credit/debit card. | Can you send me a replacement for |
| | | my lost credit card? |
| Apply Loan | User wants to apply or requests | I want to apply for a personal loan. |
| | information about personal loan, | What's the interest rate for a home |
| | home loan, mortgage loan, | loan? |
| | education loan, etc. | |
| Update Personal | User wants to change account- | Update my phone number on file. |
| Information | related details such as phone | I've shifted my home; I want to |
| | number, address, email, etc. | update the new address in my banking |
| | | records. |

A system intent is a predefined, system-driven action that the virtual assistant server 150 can take to manage the conversation in response to user inputs. Table-2 below comprises a list of system intents and corresponding descriptions, which may be predefined by an enterprise user while configuring the resolver model 222. Table-2 also comprises example user input. The system intents and the corresponding descriptions may be provided as instructions in the prompt to the resolver model 222.

TABLE 2

| System Intent | Description | Example User Input |
|---|---|---|
| Continue | The user provides information or makes | The amount to be transferred |
| | choices that directly progress the current | is $500. |
| | dialogue flow forward. | |
| Pause | The user requests a temporary halt in the | Give me a second while I find |
| | conversation, maybe to gather more | my debit card. |
| | information or for any other reason(s). | |
| Restart | The user explicitly requests to start the | Let's start over - I want to |
| | conversation over from the beginning or | begin the loan application |
| | discard any conversation till this point. | from scratch. |
| End | The user indicates the end of the current | I don't need anything else, |
| | interaction, either because the issue has been | thanks. |
| | resolved or for any other reason(s). | |
| Repeat | The user asks for the repetition of the last | Sorry, I didn't hear the |
| | message or question; when the user input | balance, could you say it |
| | received is incorrect or incomplete; or when | again? |
| | the user input is not received within a | |
| | predefined threshold time period. | |
| Refuse to | The user declines to provide the requested | I don't want to share my PIN |
| answer | information, maybe due to privacy concerns | over chat. |
| | or lack of trust. | |
| Affirmative | The user agrees with the virtual assistant's | Yes, the details are correct, |
| Confirmation | previous statement or response, moving the | please proceed with the fund |
| | conversation forward. | transfer. |
| Negative | The user disagrees with the virtual assistant's | That's not the amount I asked |
| Confirmation | previous statement or message, indicating a | to transfer. |
| | misunderstanding or incorrect information. | |
| Correction | The user wants to update or change specific | Change the transfer amount to |
| Request | details or entity values provided earlier in the | $200 instead of $500. |
| | conversation. | |
| Questions | The user asks a question that can be answered | What was the annual fee for |
| Answerable | using information explicitly stated or implied | this card you previously |
| from Context | in the conversation history. | mentioned? |
| Transfer to | The user explicitly requests to speak with or | This is going nowhere, I need |
| Human Agent | be transferred to a human agent for further | to speak to a human agent. |
| | assistance or shows frustration indicating a | |
| | preference for human support. | |

Subsequently, based on the prompt provided, the resolver model 222 determines and outputs the one or more fulfillment types 224 and the corresponding fulfillment details 226 to the virtual assistant server 150. The resolver model 222 may also determine a sentiment or emotion of the user based on at least one of: the user input 204, the conversation history 206, or the rephrased user input 210, which helps the virtual assistant server 150 in personalizing assistance and responses to the user.

A fulfillment type 224 refers to a classification of the user input 204 as: a single user intent, multiple user intents, FAQ, answer from search, ambiguous user intents, a system intent, or no intent found, although there may be other types and/or numbers of classification in other examples. The fulfillment details 226 may comprise at least one of: intent names of the one or more user intents, intent name of the system intent, one or more of the identified chunk(s) 218, one or more dialog flows 166(1)-166(n) associated with the one or more user intents to be executed, order of executing two or more of the dialog flows 166(1)-166(n) when multiple user intents are determined, a response to the user input 204, entity information identified from the user input 204 or the conversation history 206, a disambiguation prompt to the user if there is an ambiguity to be resolved between two or more user intents, or the like. The fulfillment details 226 may be determined by the resolver model 222 from the prompt provided. In one example, a conversation context object created for the ongoing interaction session comprises the fulfillment type 224 and the fulfillment details 226 output by the resolver model 222.

As illustrated in FIG. 2B, based on the one or more fulfillment types 224 and the fulfillment details 226 output by the resolver model 222, the virtual assistant server 150 executes one or more of a plurality of fulfillment tasks 228(1)-228(n) and outputs a response to the user input 204 to the user device 110(1) based on the execution of the one or more of a plurality of fulfillment tasks 228(1)-228(n). The fulfillment tasks 228(1)-228(n) may comprise: executing the one or more dialog flows 166(1)-166(n), generating one or more responses, rephrasing a response previously sent to the user device 110(1), repeating the response previously sent to the user device 110(1), generating one or more filler responses, calling one or more APIs, executing one or more scripts, executing a fallback task, discarding and restarting the conversation, transferring the conversation to a human agent at an agent device, or outputting a disambiguation prompt to the user device 110(1), although the fulfillment tasks 228(1)-228(n) may comprise other numbers of and/or types of tasks in other examples. For example, for the user input 204—“I'd like to book a flight to Miami for tomorrow, but first, could you tell me the weather forecast there for tomorrow?”, the resolver model 222 may determine and output the details comprising:
Fulfillment type: “multiple user intents”
User intent names: user intent1—“book flight”, user intent2—“get weather”
Order of execution: (i) user intent2—“get weather”, (ii) user intent1—“book flight”
Fulfillment details for user intent1—“book flight”: To city—Miami, Date—Tomorrow
Fulfillment details for user intent2—“get weather”: City—Miami, Date—Tomorrow

In the above example, based on the output of the resolver model 222, the conversation engine 170 triggers the execution of dialog flows corresponding to the user intent1—“book flight” and the user intent2—“get weather” in the order of execution determined by the resolver model 222 (i.e., the dialog flow of the user intent2—“get weather” is executed first followed by the dialog flow of the user intent1—“book flight”) and outputs one or more responses to the user device 110(1) based on the outcomes of the execution of the dialog flows.

Further, in one example, when the resolver model 222 cannot determine a user intent or a system intent from the user input 204, the resolver model 222 outputs the fulfillment type-no intent found 228(6) and fulfillment detail—“Could not determine any intent from the user input”. In this example, as shown in FIG. 2B, when the fulfillment type is “no intent found”, the conversation engine 170 triggers execution of a fallback task, which may comprise execution of a fallback dialog flow of one of the one or more dialog flows 166(1)-166(n), providing a predefined templated response to the user device 110(1) such as, for example, “I'm unbale to process your request at this moment. Please try again after some time”, “I am sorry, something went wrong. Please retry”, or the like.

Based on one or more rules provided by an enterprise user in the prompt, the resolver model 222 may prioritize: one type of intent over other type of intents, entity or entities over intent(s), or intent(s) over entity or entities, when outputting the fulfillment type 224 and the fulfillment details 226. It may be understood that these rules may be pre-defined, dynamically defined or defined in other types and/or numbers of manners in other examples.

In one example, the enterprise user may define a rule—“when both user intent and system intent are identified from a user input, prioritize the system intent over the user intent” in the prompt of the resolver model 222. For example, when the user input 204—“I want to update my shipping address, but just give me a moment”, is received from the user device 110(1), the resolver model 222 identifies a user intent—“update shipping address” and a system intent—“pause” from the user input 204. Based on the defined rule, the system intent—“pause” is prioritized over the user intent, causing the virtual assistant server 150 to suspend the execution of the update shipping address dialog flow until a subsequent user input is received from the user device 110(1).

In another example, the enterprise user may define a rule—“when both system intent and one or more entities corresponding to a current dialog flow under execution are identified from a user input, prioritize the system intent over the one or more entities”, in the prompt of the resolver model 222. For example, when the user input 204—“My account number is 307269481, but hold on a second while I reconfirm it”, is received from the user device 110(1) while executing a dialog flow of the user intent—“check balance”, the resolver model 222 identifies an entity value—“307269481” corresponding to an entity—“account number” and a system intent—“pause” from the user input 204. In this example, based on the enterprise user defined rule, the resolver model 222 prioritizes the system intent—“pause” over the entity value, causing the virtual assistant server 150 to suspend the execution of the dialog flow of the user intent—“check balance” until a subsequent user input is received from the user device 110(1). This ensures enhanced user experience and reduced processor execution cycles.

In another example, the enterprise user may define a rule—“when both system intent and one or more entities corresponding to a current dialog flow under execution are identified from a user input, prioritize the one or more entities over the system intent” in the prompt of the resolver model 222. For example, when the user input 204—“My savings account number is 307269481, but hold on a second while I reconfirm it”, is received from the user device 110(1) while executing a dialog flow of the user intent—“check balance”, the resolver model 222 identifies an entity value-“307269481” corresponding to an entity—“account number” and a system intent—“pause” from the user input 204. In this example, based on the enterprise user defined rule, the resolver model 222 prioritizes the entity value—“307269481” over the system intent—“pause”, causing the virtual assistant server 150 to continue with the execution of the dialog flow of the user intent—“check balance” based on the identified entity value.

The resolver model 222 is also configured to determine fulfillment details corresponding to the system intents. The virtual assistant server 150 controls the execution state of a dialog flow between a user and the virtual assistant server 150 based on the system intent determined. Each system intent output by the resolver model 222 may be associated with one or more fulfillment tasks that define the actions to be performed by the virtual assistant server 150. For example, when the resolver model 222 outputs a fulfillment type: “system intent” and fulfillment details: “continue”, the virtual assistant server 150 continues execution of the current dialog flow by processing the provided user input 204 and advancing to the next step or goal of the current dialog flow. When the resolver model 222 outputs a fulfillment type: “system intent” and fulfillment details: “pause”, the virtual assistant server 150 pauses execution of the current dialog flow and holds the state of the interaction until a subsequent user input is received, at which point the execution of the dialog flow may be resumed. When the resolver model 222 outputs a fulfillment type: “system intent” and fulfillment details: “restart”, the virtual assistant server 150 discards the context of the current dialog flow and re-initiates execution of the dialog flow from the beginning. When the resolver model 222 outputs a fulfillment type: “system intent” and fulfillment details: “end”, the virtual assistant server 150 terminates the execution of the current dialog flow and generates a closing response to the user. In other examples, the resolver model 222 may generate fulfillment type: “system intent” with fulfillment details such as repeat, refuse to answer, affirmative confirmation, negative confirmation, or correction request, although there may be other types and/or numbers of system intents may be configured in other examples. Each of these system intents corresponds to a fulfillment task that respectively cause the virtual assistant server 150 to: repeat a prior message, decline to proceed without user-provided information, continue the interaction, re-execute a part of the dialog flow or start execution of another dialog flow, or update previously provided details in the dialog flow. Accordingly, the resolver model 222 acts as a dialog state manager, where each fulfillment type of system intent determines whether the virtual assistant server 150 continues, pauses, restarts, ends, or modifies the execution of a dialog flow.

Although not illustrated in FIGS. 2A and 2B, the conversation engine 170 of the virtual assistant server 150 orchestrates the communication between different components or models of FIGS. 2A and 2B. Additionally, the conversation engine 170 also prompts the models—208, 212, 216, and 222 by retrieving and using corresponding prompt templates from the prompt library 172. Furthermore, the conversation engine 170 may also execute the one or more of the plurality of fulfillment tasks 228(1)-228(n) based on the output of the resolver model 222 and outputting the responses to the user device 110(1).

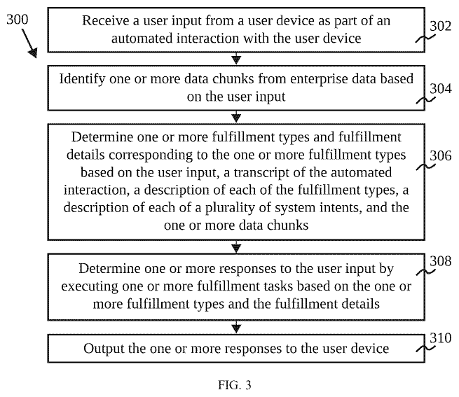

FIG. 3 is a flowchart of an exemplary method 300 for managing and orchestrating conversations at the virtual assistant server 150 illustrated in FIG. 1. The virtual assistant server 150 may interact with other components of the environment 100 to perform the steps of the exemplary method 300. In FIG. 3, the ordering of steps of method 300 is exemplary and any other ordering of the steps may be possible, not all the steps may be required, and in some implementations, some steps may be omitted, or other steps may be added.

At step 302, the virtual assistant server 150 receives a user input 204 from one of the one or more user devices 110(1)-110(n), for example, a user device 110(1) as part of an automated interaction with the user device 110(1). The user input 204 may be provided at one of the one or more user devices 110(1)-110(n) in the form of text, voice, or a combination of both these inputs. In one example, the virtual assistant server 150 generates a vector of the user input 204 received from the user device 110(1). Further, if conversation history 206 already exists for the conversation, the user input 204 is first contextually rephrased (as described above in view of FIG. 2A) based on the conversation history 206 and then the vector of rephrased user input 214 is generated instead of generating the vector of the user input 204.

At step 304, the virtual assistant server 150 identifies one or more data chunks from the enterprise data based on the user input 204. In one example, the virtual assistant server 150 identifies the one or more data chunks from the enterprise data by calculating similarity scores between the vector of the user input and each of a plurality of vectors of enterprise data 202. In one example, the similarity scores are calculated between the vector of rephrased user input 214 and each of the plurality of vectors of enterprise data 202 (as described above in view of FIG. 2A). Further, based on the calculated similarity scores, the virtual assistant server 150 identifies one or more of the plurality of vectors of enterprise data 202 that have a similarity score greater than or equal to a threshold (e.g., 0.6) set by the enterprise user at the one or more developer devices 120(1)-120(n) as the one or more data chunks.

At step 306, the virtual assistant server 150 determines the one or more fulfillment types 224 from a plurality of fulfillment types and the fulfillment details 226 corresponding to the one or more fulfillment types 224 based on a plurality of inputs comprising: the user input 204, the conversation history 206 (i.e., transcript of the automated interaction), a description of each of a plurality of system intents 220, and identified chunks 218 along with the corresponding calculated similarity score.

At step 308, the virtual assistant server 150 determines one or more responses to the user input 204 by executing one or more of the plurality of fulfillment tasks 228(1)-228(n) based on the one or more fulfillment types 224 and the fulfillment details 226 determined at step 306.

Subsequently, at step 310, the virtual assistant server 150 outputs to the user device 110(1), the one or more responses determined at step 308.

Additionally, the steps 302-310 may be repeated until an end of the automated interaction with the user device 110(1) is identified, in which case, the resolver model 222, in one example, outputs a fulfillment type—“system intent” and fulfillment detail—“end”. Upon the resolver model 222 outputting the fulfillment type—“system intent” and the fulfillment detail-“end”, the virtual assistant server 150 terminates the execution of the current dialog flow and outputs a closing response to the user device 110(1).

In another example, the steps 302-310 may be repeated until the resolver model 222 outputs a fulfillment type—“no intent found” and fulfillment detail—“could not identify an intent from the user input.” In this example, the virtual assistant server 150 terminates the execution of the current dialog flow and outputs a templated response to the user device 110(1) such as, for example, “Sorry, I did not understand your input. I'm discarding the current interaction. Thank you.”

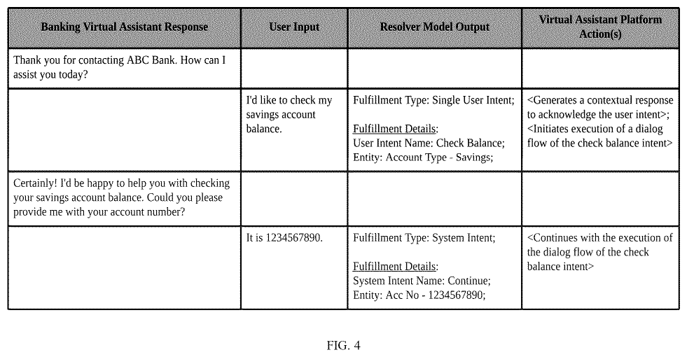

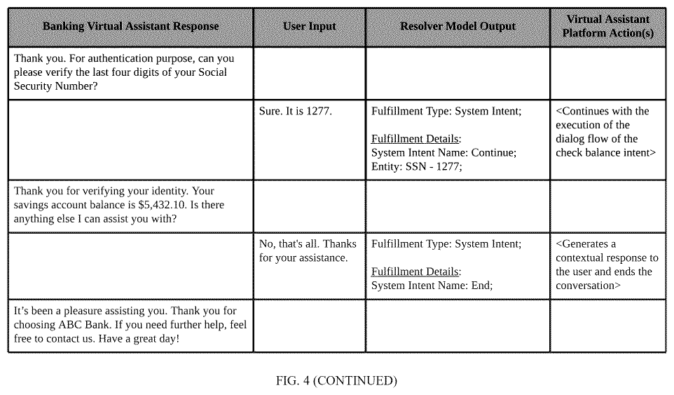

Referring to FIG. 4, a table is illustrated of an exemplary conversation data between the user at the user device 110(1) and a banking virtual assistant 164(1), output of the resolver model 222, and corresponding actions of the virtual assistant platform 160. As illustrated in FIG. 4, during a conversation between the user at the user device 110(1) and the banking virtual assistant 164(1), each user input 204 received from the user device 110(1) may be processed (as described in view of FIG. 2A) and the resolver model 222 outputs the fulfillment type 224 and the fulfillment details 226, based on which the conversation engine 170 of the virtual assistant platform 160 executes corresponding fulfillment tasks 228(1)-228(n) until the conversation ends.

As illustrated, the virtual assistant server 150 determines a manner of executing a dialog flow or a task corresponding to the user intent based on the system intent. In one example, the banking virtual assistant 164(1) is configured with one or more deterministic flows. When the user input 204—“I'd like to check my savings account balance” is received by the virtual assistant server 150 and the user intent determined as “check balance” by the resolver model 222, the virtual assistant server 150 executes a dialog flow 166(1) associated with that the user intent—“check balance”. Subsequently during the execution of the dialog flow 166(1) associated with the user intent—“check balance”, the virtual assistant server 150 prompts the user for the account number. The user provides the account number and the resolver model 222 determines a system intent: “continue”. Based on the determined system intent—“continue”, the virtual assistant server 150 continues with the execution of the dialog flow 166(1) of the user intent—“check balance”. However, if the user provides an incorrect or incomplete account number, the resolver model 222 determines a system intent: “repeat”. Based on the determined system intent—“repeat”, the virtual assistant server 150 re-executes a corresponding entity node in the dialog flow 166(1) of the user intent—“check balance” to re-collect the account number. In this manner, the virtual assistant server 150 determines a manner of executing the dialog flow 166(1) corresponding to the user intent based on the system intent.

In some examples, the one or more virtual assistants 164(1)-164(n) may be implemented as AI agents. The AI agents may be configured to operate individually or in coordination with one another, depending on the requirements of a given enterprise application. In one configuration, the one or more virtual assistants 164(1)-164(n) may comprise supervisors, orchestrating and delegating tasks to one or more subordinate worker agents. In another configuration, the one or more virtual assistants 164(1)-164(n) may function as a worker-only agent, executing fulfillment tasks as directed by other components. Other types and/or numbers of AI agent architectures may also be employed, including cooperative, hierarchical, or autonomous multi-agent frameworks, thereby enabling flexible deployment and management of conversational and task-oriented flows.

In another example, the banking virtual assistant 164(1) is configured as an AI agent without deterministic flows. In this example, when the user input 204—“I'd like to check my savings account balance” is received by the virtual assistant server 150 and the user intent determined as “check balance”, the virtual assistant server 150 initiates executing a task of “checking account balance”. Subsequently during the execution of the task, the virtual assistant server 150 prompts the user for the account number. If the user provides an incorrect or incomplete account number, the resolver model 222 determines a system intent: “repeat”. Based on the system intent, the virtual assistant server 150 re-prompts the user to provide the correct account number, ensuring the task of checking account balance can proceed once accurate information is received.

### Advantages of Examples of this Technology Include

Reducing or eliminating the need for extensive training data to train the virtual assistants. Instead, examples of this technology just require vectorized chunks of: user intents, FAQs, and/or enterprise knowledge to be represented in one or more vector indices. This significantly reduces the time required to build virtual assistants.

The user intents, FAQs, and the enterprise knowledge are created as chunks and represented in one or more vector indices. This eliminates the need for setting the precedence between user intents, FAQs answering, and knowledge search.

Enables the enterprises to efficiently manage common conversation events such as, for example, pause conversation, end conversation, restart conversation, repeat information, transfer to a human agent, etc.

Efficiently manages resolution of ambiguous user intents.

Simplifies the training and maintenance of user intents across the virtual assistants by unifying all the intent types (user intents, FAQs, and/or enterprise knowledge) and representing them in vector indices.

Better handle the user inputs that contain negations.

Having thus described the basic concept of the invention, it will be rather apparent to those skilled in the art that the foregoing detailed disclosure is intended to be presented by way of example only and is not limiting. Various alterations, improvements, and modifications will occur and are intended for those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A method comprising:
receiving, by a virtual assistant server, a user input from a user device as part of an automated interaction with the user device;
identifying, by the virtual assistant server, one or more data chunks from enterprise data based on the user input;
determining, by the virtual assistant server, one or more fulfillment types and fulfillment details corresponding to the one or more fulfillment types based on the user input, a transcript of the automated interaction, a description of each of the fulfillment types, a description of each of a plurality of system intents, and the one or more data chunks;
determining, by the virtual assistant server, one or more responses to the user input by executing one or more fulfillment tasks based on the one or more fulfillment types and the fulfillment details; and
outputting, by the virtual assistant server, the one or more responses to the user device.

2. The method of claim 1, wherein the identifying the one or more data chunks from the enterprise data comprises:
generating a vector of the user input;
calculating similarity scores between the user input vector and a vector of each of the one or more data chunks of the enterprise data; and
identifying, based on the calculating, the one or more of the data chunks whose corresponding vector has the calculated similarity score greater than or equal to a threshold.

3. The method of claim 1, wherein the enterprise data comprises at least one of: one or more user intent names and corresponding descriptions; one or more frequently asked questions (FAQs) and corresponding alternate questions; or descriptions of: one or more enterprise products, one or more services, or policy data.

4. The method of claim 1, wherein the one or more fulfillment types comprise: a single user intent, multiple user intents, a frequently asked question (FAQ), an answer from search, ambiguous user intents, a system intent, or no intent found.

5. The method of claim 1, wherein the fulfillment details corresponding to the one or more fulfillment types comprise at least one of: user intent names of one or more user intents, system intent name of one of the system intents, one or more dialog flows to be executed, the one or more data chunks, entities identified from the automated interaction, or a disambiguation prompt to be sent to the user device when there is an ambiguity to be resolved between two or more of the user intents.

6. The method of claim 1, wherein the one or more fulfillment tasks comprise: executing one or more dialog flows, generating the one or more responses, rephrasing a response previously sent to the user device, repeating the response previously sent to the user device, and generating one or more filler responses.

7. The method of claim 1, wherein the one or more fulfillment tasks comprise: triggering a fallback task, discarding and restarting the conversation, transferring the conversation to a human agent at an agent device, and outputting a disambiguation prompt to the user device.

8. A virtual assistant server comprising:
one or more processors; and
a memory coupled to the one or more processors which are configured to execute programmed instructions stored in the memory to:
receive a user input from a user device as part of an automated interaction with the user device;
identify one or more data chunks from enterprise data based on the user input;
determine one or more fulfillment types and fulfillment details corresponding to the one or more fulfillment types based on the user input, a transcript of the automated interaction, a description of each of the fulfillment types, a description of each of a plurality of system intents, and the one or more data chunks;
determine one or more responses to the user input by executing one or more fulfillment tasks based on the one or more fulfillment types and the fulfillment details; and
output the one or more responses to the user device.

9. The virtual assistant server of claim 8, wherein to identify the one or more data chunks, the one or more processors are further configured to execute programmed instructions stored in the memory to:
generate a vector of the user input;
calculate similarity scores between the user input vector and a vector of each of the one or more data chunks of the enterprise data; and
identify, based on the calculated similarity scores, the one or more of the data chunks whose corresponding vector has the calculated similarity score greater than or equal to a threshold.

10. The virtual assistant server of claim 8, wherein the enterprise data comprises at least one of: one or more user intent names and corresponding descriptions; one or more frequently asked questions (FAQs) and corresponding alternate questions; or descriptions of: one or more enterprise products, one or more services, or policy data.

11. The virtual assistant server of claim 8, wherein the one or more fulfillment types comprise: a single user intent, multiple user intents, a frequently asked question (FAQ), an answer from search, ambiguous user intents, a system intent, or no intent found.

12. The virtual assistant server of claim 8, wherein the fulfillment details corresponding to the one or more fulfillment types comprise at least one of: user intent names of one or more user intents, system intent name of one of the system intents, one or more dialog flows to be executed, the one or more data chunks, entities identified from the automated interaction, or a disambiguation prompt to be sent to the user device when there is an ambiguity to be resolved between two or more of the user intents.

13. The virtual assistant server of claim 8, wherein the one or more fulfillment tasks comprise: executing one or more dialog flows, generating the one or more responses, rephrasing a response previously sent to the user device, repeating the response previously sent to the user device, and generating one or more filler responses.

14. The virtual assistant server of claim 8, wherein the one or more fulfillment tasks comprise: triggering a fallback task, discarding and restarting the conversation, transferring the conversation to a human agent at an agent device, and outputting a disambiguation prompt to the user device.

15. A non-transitory computer-readable medium storing instructions which when executed by one or more processors, causes the one or more processors to:
receive a user input from a user device as part of an automated interaction with the user device;
identify one or more data chunks from enterprise data based on the user input;
determine one or more fulfillment types and fulfillment details corresponding to the one or more fulfillment types based on the user input, a transcript of the automated interaction, a description of each of the fulfillment types, a description of each of a plurality of system intents, and the one or more data chunks;
determine one or more responses to the user input by executing one or more fulfillment tasks based on the one or more fulfillment types and the fulfillment details; and
output the one or more responses to the user device.

16. The non-transitory computer-readable medium of claim 15, wherein to identify the one or more data chunks, the non-transitory computer-readable medium further comprises instructions which when executed by the one or more processors, causes the one or more processors to:
generate a vector of the user input;
calculate similarity scores between the user input vector and a vector of each of the one or more data chunks of the enterprise data; and
identify, based on the calculated similarity scores, the one or more of the data chunks whose corresponding vector has the calculated similarity score greater than or equal to a threshold.

17. The non-transitory computer-readable medium of claim 15, wherein the enterprise data comprises at least one of: one or more user intent names and corresponding descriptions; one or more frequently asked questions (FAQs) and corresponding alternate questions; or descriptions of: one or more enterprise products, one or more services, or policy data.

18. The non-transitory computer-readable medium of claim 15, wherein the one or more fulfillment types comprise: a single user intent, multiple user intents, a frequently asked question (FAQ), an answer from search, ambiguous user intents, a system intent, or no intent found.

19. The non-transitory computer-readable medium of claim 15, wherein the fulfillment details corresponding to the one or more fulfillment types comprise at least one of: user intent names of one or more user intents, system intent name of one of the system intents, one or more dialog flows to be executed, the one or more data chunks, entities identified from the automated interaction, or a disambiguation prompt to be sent to the user device when there is an ambiguity to be resolved between two or more of the user intents.

20. The non-transitory computer-readable medium of claim 15, wherein the one or more fulfillment tasks comprise: executing one or more dialog flows, generating the one or more responses, rephrasing a response previously sent to the user device, repeating the response previously sent to the user device, and generating one or more filler responses.

21. The non-transitory computer-readable medium of claim 15, wherein the one or more fulfillment tasks comprise: triggering a fallback task, discarding and restarting the conversation, transferring the conversation to a human agent at an agent device, and outputting a disambiguation prompt to the user device.
